(19) United States
(12) Patent Application Publication
(10) Pub. No.: US 2019/0344183 A1
(43) Pub. Date: Nov. 14, 2019

(54) SYSTEM AND METHOD FOR AUTO-TIERING ALLIANCES IN MULTIPLAYER ONLINE GAMES

(71) Applicant: MZ IP Holdings, LLC, Palo Alto, CA (US)

(72) Inventor: Matt Walsh, San Carlos, CA (US)

(21) Appl. No.: 16/408,801

(22) Filed: May 10, 2019

Related U.S. Application Data
(60) Provisional application No. 62/671,038, filed on May 14, 2018.

(51) Int. Cl. A63F 13/798; A63F 13/795

(52) U.S. Cl. CPC A63F 13/798; A63F 13/795

(57) ABSTRACT

A computer-implemented method for organizing players of a multiplayer online game as members of one or more alliances, the method including: evaluating characteristics of each member in each alliance, wherein each alliance includes multiple alliance tiers and each alliance tier includes a portion of the members of the alliance; generating a score for each member of the alliance based on the evaluation (e.g., applying a tier scoring function (TSF)); ranking each member in each alliance according to the generated scores; assigning, based on the ranking, each member to one of the alliance tier; and updating the multiplayer online game according to the assignments.

### CROSS-REFERENCE TO RELATED APPLICATIONS

This application claims the benefit of U.S. Provisional Patent Application No. 62/671,038, filed on May 14, 2018, the entire contents of which are incorporated by reference herein.

### BACKGROUND

The present disclosure relates to multiplayer online games and, in particular, to systems and methods for improving and prioritizing alliances between players and groups of players in the multiplayer online game.

In general, a multiplayer online game can be played by hundreds of thousands or even millions of players who use client devices to interact with a virtual environment for the online game. The players are typically working to accomplish tasks, acquire assets, or achieve a certain score in the online game. Some games require or encourage players to form groups or teams (i.e., alliances) that can play against other alliances. Indeed, such alliances provide a framework for cooperation, camaraderie, and teamed events.

In general, player enjoyment in an online game, especially in massive, multiplayer online games that include a plurality of alliances, may depend on how engaged each member of the alliance is in the game. For example, when a member interacts with other members in her alliance who are highly engaged or involved in the game, the member's experience with the game can be more enjoyable. On the other hand, if a member is interacting with members in her alliance who are not actively participating in the game, the member is more likely to lose interest in the game.

The use and management of alliances, however, pose numerous challenges to the members within the alliance. For example, in gameplay that includes multiple alliances, alliance members may earn or may be assigned a rank within the alliance. Typical ranks may fall into three or more tiers: ordinary members, co-leaders, and leaders, for example. Conventionally, a single member may hold the status as “leader,” entitling her to ultimate control of the alliance, which may include: establishing alliance policies, accepting applicants into the alliance as members, rejecting applicants, ousting alliance members, appointing of co-leaders, promoting members, and even disbanding the alliance. One or more co-leaders may be selected or appointed (e.g., by the leader) to exercise superior control over the members, short of that exercised by the leader. For example, co-leaders may be able to accept or reject applicants and oust alliance members; they may not be able to disband the alliance or oust the leader or another co-leader.

Establishing alliance policies, which may lie in the exclusive domain of the leader, may include, for example, establishing a hierarchy and control mechanisms that allow the alliance to be self-governing. Underlying these policies is the ultimate goal or mission of the alliance and the need for each member to contribute to achieving that goal or accomplishing that mission. Accordingly, it is in the collective best interest of the alliance to retain productive members whose play and dedication to the alliance best achieve that goal or accomplish that mission.

Problematically, alliances become progressively more difficult to manage with increased membership size. Typically, the number of members within an alliance is about 50, beyond which it becomes increasingly more difficult for leaders (and co-leaders) to evaluate each member of the alliance to determine his/her disposition as a player and his/her value to the alliance.

The flipside of limiting an alliance size to 50 is the issue of concurrency. Recognizing that alliances may only work well when multiple members of the alliance are online at the same time, limiting an alliance to 50 members may diminish the appeal of a particular alliance or alliances in general. Indeed, some of the advantages of alliances are the camaraderie and social interaction that the alliance and a group effort instill. When alliance membership is limited, instances may occur when a single member or a very limited number of members have no one to chat or socialize with. Moreover, when there is a single member, there is no opportunity to cooperate and build teamwork.

Although some massive, multiplayer online games—particularly games in which players may spend hours engaged—create a higher likelihood of having a critical mass of alliance members playing concurrently, for other games—especially those games in which members tend to play for a shorter duration of time—the likelihood of having a teammate playing concurrently is reduced. A larger alliance size likely would address the shortcomings of concurrency, hence the dichotomy.

Auxiliary (e.g., sister or feeder) alliances have been used to infuse alliances with new, talented members to replace alliance members who have stopped or reduced play due to lack of interest in the game or in the alliance. Loss of allegiance to or interest in the alliance may stem from social issues not related to the game itself, as well as from, for example, displeasure with the alliance's leadership, the member's status within the alliance, and the overall success of the alliance in gameplay. The use of auxiliary alliances is analogous to major league baseball organizations having farm teams, in which the manager of the major league ball club and the manager of the minor league ball club must coordinate between each other to decide which players to bring up to the big leagues (i.e., to be promoted) and which players to send back down (i.e., to be demoted) to AA- or AAA-ball.

The creation and use of auxiliary alliances generally remain ad hoc and require significant manual effort to monitor. Furthermore, the loose affiliation between the alliance and an ad hoc, auxiliary alliance may rely solely on the yeah or nay of the alliance's leader having imperfect knowledge of the qualities and attributes of a player in an auxiliary alliance. Ad hoc alliances also may not be supported by the game itself; hence, the members involved may not be readily seen (e.g., in action) by alliance leaders and decision makers. For example, in addition to monitoring all of the members in her alliance, the alliance's leader or decision makers looking for new talent would also have to monitor the play of members in the auxiliary alliance, which typically cannot be done while the leader is concurrently playing the game herself. Other pitfalls may include bookkeeping, cross-team administration, communication between leaders in the alliances, and so forth: all of which may have to be performed manually.

The foregoing discussion, including the description of motivations for some embodiments of the invention, is intended to assist the reader in understanding the present disclosure, is not admitted to be prior art, and does not in any way limit the scope of any of the claims.

### SUMMARY

In certain examples, the systems and methods described herein can be used to automatically organize players of a multiplayer online game into a plurality of alliances and, within each alliance, into a plurality of alliance tiers. The players can be organized based on performance rankings for the online game, for example, with better players being assigned to higher or more competitive alliance tiers. The automatic alliance tier assignments can greatly enhance user interest in the online game, by rewarding players who perform well, have high engagement with the game, and/or are valuable alliance members. In the context of a massive, multiplayer online game, involving thousands or millions of players, the approach described herein can significantly reduce efforts required by game managers to manage alliances and alliance tiers. Computer performance can be enhanced by reducing or eliminating repeated and time-consuming calculations and/or network hops associated with alliance management. For example, communications among client devices for purposes of alliance management can be greatly reduced or eliminated (e.g., by a factor of 2, 10, or more).

In a first aspect, the subject matter described in this specification relates to a method for organizing players of a multiplayer online game as members of one or more alliances. In some embodiments, the method includes evaluating characteristics of each member in each alliance, wherein each alliance includes multiple alliance tiers and each alliance tier includes a portion of the members of the alliance; generating a score for each member of the alliance based on the evaluation (e.g., applying a tier scoring function (TSF)); ranking each member in each alliance according to the generated scores; assigning, based on the ranking, each member to one of the alliance tiers; and updating the multiplayer online game according to the assignments. In some implementations, the TSF may be applied continuously or periodically and may include evaluating: a level of engagement of each alliance member with the multiplayer online game, a loyalty of the member to the member's alliance, and/or an ELO rating for the member. In some variation, a weighting factor may be applied to the level of engagement of the member, the loyalty of the member, and/or the ELO rating for the member.

In some applications, the method may also include one or more of: periodically resetting the score and the ranking of each member, periodically purging members in a bottom tier from the alliance, and/or evaluating characteristics of each alliance in the multiplayer online game and generating an alliance score for the alliance (e.g., applying a tier scoring function (TSF) to the alliance) based on the evaluation. In further applications, the method may also include providing an in-game reward to a player(s) of multiplayer online game, wherein providing the in-game reward may include calculating a multiplier based on the alliance tier of the player and on an alliance score of the alliance of the corresponding player.

In a second aspect, the subject matter described in this specification relates to a system for organizing players of a multiplayer online game as members of one or more alliances. In some embodiments, the system includes one or more computer processors programmed to perform operations that include evaluating characteristics of each member in each alliance, wherein each alliance includes multiple alliance tiers and each alliance tier includes a portion of the members of the alliance; generating a score for each member of the alliance based on the evaluation (e.g., applying a tier scoring function (TSF)); ranking each member in each alliance according to the generated scores; assigning, based on the ranking, each member to one of the alliance tiers; and updating the multiplayer online game according to the assignments. In some implementations, the TSF may be applied continuously or periodically and may include evaluating: a level of engagement of each alliance member with the multiplayer online game, a loyalty of the member to the member's alliance, and/or an ELO rating for the member. In some variation, a weighting factor may be applied to the level of engagement of the member, the loyalty of the member, and/or the ELO rating for the member.

In some applications, the operations performed by the computer processors may also include one or more of: periodically resetting the score and the ranking of each member, periodically purging members in a bottom tier from the alliance, and/or evaluating characteristics of each alliance in the multiplayer online game and generating an alliance score for the alliance (e.g., applying a tier scoring function (TSF) to the alliance) based on the evaluation. In further applications, the operations performed by the computer processors may also include providing an in-game reward to a player(s) of multiplayer online game, wherein providing the in-game reward may include calculating a multiplier based on the alliance tier of the player and on an alliance score of the alliance of corresponding the player.

In a third aspect, the subject matter described in this specification relates to an article. In some embodiments, the article includes a non-transitory computer-readable medium having instructions stored thereon that, when executed by one or more computer processors, cause the computer processors to perform operations including: evaluating characteristics of each member in each alliance, wherein each alliance includes multiple alliance tiers and each alliance tier includes a portion of the members of the alliance; generating a score for each member of the alliance based on the evaluation (e.g., applying a tier scoring function (TSF)); ranking each member in each alliance according to the generated scores; assigning, based on the ranking, each member to one of the alliance tiers; and updating the multiplayer online game according to the assignments.

Elements of embodiments described with respect to a given aspect of the invention may be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an exemplary system for organizing members of an alliance into a plurality of alliance tiers.

FIG. 2 is a schematic diagram of an exemplary system for organizing members of an alliance into a plurality of alliance tiers.

FIG. 3 is a flowchart of an exemplary method of organizing members of an alliance into a plurality of alliance tiers.

### DETAILED DESCRIPTION

In general, the systems and methods described herein can be used to evaluate players and/or groups of players of a massive, multiplayer online game or other suitable application client, and, more specifically, to evaluate members of an alliance for the purpose of assigning each member into an appropriate alliance tier within the alliance. A “player” or a “group of players” may refer to individuals playing a massive, multiplayer online game or otherwise interacting with an appropriate application client. In certain instances, a player may alternatively be referred to herein as a “user.” A player that has been assigned to or has joined an alliance may be referred to as a “member” of that alliance. Members of an alliance generally work together to accomplish or reach a common goal. An “alliance” may alternatively be referred to herein as a “team” or “group.” Thus, typically, alliance members or groups of alliance members compete with members or groups of members of one or more other alliances in the online game. An “alliance tier” may refer to a subgroup within the alliance to which one or more members of the alliance may be assigned, e.g., based on an evaluation and ranking of each member of the alliance. For purposes of illustration and not limitation, the present invention will be described in terms of a massively multiplayer online (MMO) game, although the present invention can be used in any suitable application client to organize and manage large groups of users.

In certain examples, the grouping of alliance members into an alliance tier may be a measure of how active and/or how successful the member is in the online game, as well as how loyal the member may be to the alliance. By evaluating each member of an alliance, the systems and methods described herein are able to rank members and groups of members according to, inter alia: their proficiency of play, their dedication and commitment to the online game, and/or their loyalty to the alliance. More particularly, the systems and methods described herein may be adapted to assign each member of an alliance to an appropriate tier within the alliance based on a score calculated for each member as compared to the scores of other members in the alliance. By scoring and ranking members within participating alliances based on member scores, overall player and member enjoyment and satisfaction with the game can be enhanced.

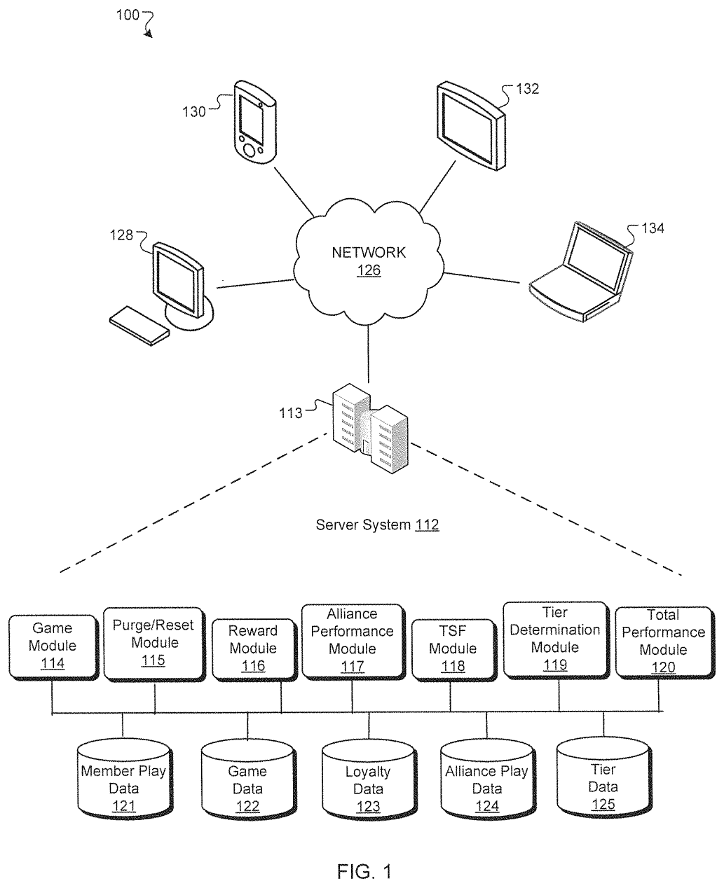

FIG. 1 illustrates an exemplary system 100 for use in organizing players of a massive, multiplayer online game—and, more particularly, members of an alliance within the online game—into an appropriate tier within the respective member's alliance. A server system 112 provides functionality for evaluating the alliance as well as each alliance member to determine scores for each alliance and for each member of the alliance for the purpose of assigning each member to an appropriate tier within the respective member's alliance. The server system 112 includes software components and databases that can be deployed at one or more data centers 113 in one or more geographic locations, for example. In some implementations, the server system 112 software components may include a game module 114, a purge-reset module 115, a reward module 116, an alliance performance module 117, a tier scoring function (TSF) module 118, a tier determination module 119, and a total performance module 120. The software components can include subcomponents that can execute on the same or on different individual data processing apparatus. The server system 112 databases may include, for the purpose of illustration rather than limitation, databases that collect and store: member play data 121, game data 122, loyalty data 123, alliance play data 124, and tier data 125. The databases can reside in one or more physical storage systems. The software components and data will be further described below.

An application, such as, for example, a web-based application, may be provided as an end-user application to allow users to interact with the server system 112. The end-user application can be accessed through a network 126 (e.g., the Internet) by users of client devices, such as a personal computer 128, a smart phone 130, a tablet computer 132, a laptop computer 134, and the like. Other client devices are possible. In alternative examples, member play data 121, game data 122, loyalty data 123, alliance play data 124, and/or tier data 125, or any portions thereof, may be stored on one or more client devices. Additionally or alternatively, software components for the system 100 (e.g., the game module 114, the purge-reset module 115, the reward module 116, the alliance performance module 117, the TSF module 118, the tier determination module 119, and the total performance module 120) or any portions thereof can reside on or be used to perform operations on one or more client devices.

FIG. 1 depicts the game module 114, the purge-reset module 115, the reward module 116, the alliance performance module 117, the TSF module 118, the tier determination module 119, and the total performance module 120 as being able to communicate with the databases (e.g., databases that collect and store: member play data 121, game data 122, loyalty data 123, alliance play data 124, and/or tier data 125). The member play data 121 database generally includes information related to the individual contributions of each member in furtherance of the mission or goal of the alliance to which the member is affiliated. Such information can be or include, for example, member accomplishments (e.g., member victories or other measures of success), member tasks, member interactions with other players (e.g., group chats), member purchases, and/or member item usage. The game data 122 database generally includes information related to the multiplayer online game implemented using the system 100. In some applications, the game data 122 database may include, for example, information related to a virtual environment for the game, image, video and/or audio data for the game, event data corresponding to previous, current or future events, and/or game state data defining a current state of the game. The loyalty data 123 database generally includes data related to member interactions with the online game and/or the virtual environment. Such information can be or include, for example, a history of member connections to the system 100 (e.g., the amount of time of play), member purchases, member interactions with other players (e.g., group chats), and member purchases.

The alliance play data 124 database generally includes information related to the collective contributions of all members in furtherance of the mission or goal of the alliance as compared to other, competing alliances. Such information can be or include, for example, a history of alliance membership, alliance accomplishments (e.g., group victories or other measures of success), alliance tasks, alliance leadership (e.g., an identification of an alliance leader), and/or alliance chats.

The tier data 125 database generally includes information related to the alliance tiers. In some implementations, these data may be determined by alliance leadership. Such information can be or include, for example, preferences as to the number of tiers in the alliance, as well as the proportion of the alliance membership assigned to each alliance.

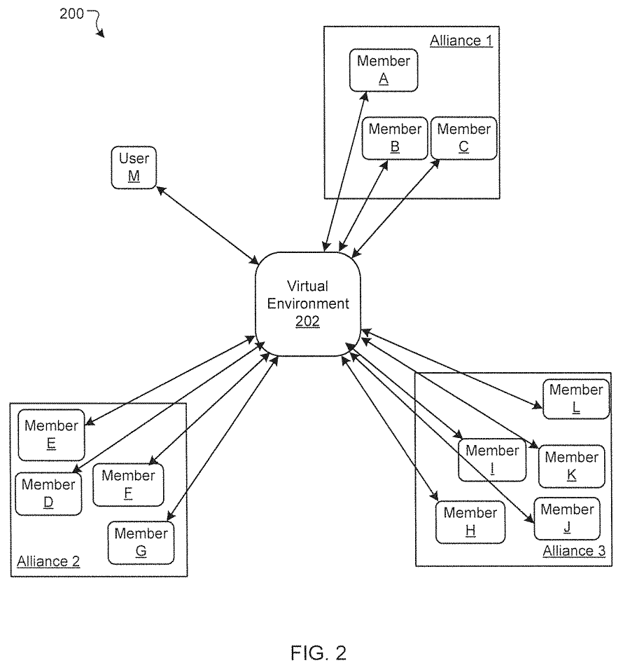

Referring to FIG. 2, in various examples, an online game 200 may include a plurality of alliances that include members who interact with a virtual environment 202. In the depicted example, the online game 200 includes players A-M and alliances 1-3. Alliance 1 includes members A, B, and C; alliance 2 includes members D, E, F, and G; and alliance 3 includes members H, I, J, K, and L. Player M is not presently assigned to any alliance.

In general, the game module 114 can implement the virtual environment 202, coordinate events, and advance the state of the game. As players A-M and alliances 1-3 interact with the virtual environment 202, information related to the interactions can be stored, for example, in the member play data 121 database, the loyalty data 123 database, and the alliance play data 124 database. In some implementations, the TSF module 118 can use, for example, member play data 121 and loyalty data 123 to calculate a score for each member of the alliance. In general, an individual score for a member of an alliance provides an indication of how active the member is in the virtual environment 202, as well as how successful the member is. Exemplary factors that the TSF module 118 may use to calculate the TSF may include, for the purpose of illustration rather than limitation: matches won/lost, ELO score, number of days as a member of the alliance, login streak (i.e., how many consecutive days has the player logged in), amount of money spent, player “power” (i.e., the value of the player's virtual game possessions), and so forth.

The scores for each alliance member may also be used to rank the members within the alliance, so that the members may be partitioned into various tiers within the alliance. In some embodiments, the alliance tiers may be similar, in concept and function, to those used, for example, in professional baseball. For example, as shown in Table 1, baseball players within a major league baseball organization may be tiered (e.g., based on performance and statistics) in one of three levels: major league, AAA minor league, or AA minor league. Ball players within the organization may be assigned to one of the three tiers based on their demonstrated objective performance and subjective potential.

TABLE 1
Tiered Organization of Professional Baseball Teams.

| | Team | | |
|---|---|---|---|
| Tier | Yankees | Giants | Cardinals |

Major League
Minor League (AAA)
Minor League (AA)

In general, the tier determination module 119 may be configured to use, for example, member play data 121, loyalty data 123, and tier data 125, as well as the results of the TSF module 118 (i.e., the scores and ranking of the alliance members) to create a number of tiers within the alliance membership and, moreover, to assign individual members of the alliance to a discrete tier based on the member's score and ranking within the alliance. Those skilled in the art can appreciate that an alliance may include any number of tiers and that portions of the membership are assigned to one of the tiers based on the member's score and ranking. For example, a representative alliance may include three tiers: a top tier, a bottom tier, and a middle tier. The top tier may include, for example, the top ten percent of the ranked members; the bottom tier may include, for example, the bottom 70 percent of the ranked members; and the middle tier may include, for example, the 20 percent of the ranked members who are neither in the top tier nor in the bottom tier. Exemplary alliances with tiered organizations are shown in Table 2. Although Table 2 shows that Alliances 1-3 each have a top tier, a middle tier, and a bottom tier that include, respectively, 10% of the corresponding alliance's members, 20% of the corresponding alliance's members, and 70% of the corresponding alliance's members, this is done for illustrative purposes only. Those of ordinary skill in the art can appreciate that, alternatively, the tiers in Alliance 1 may have 10/20/70 mix, while the tiers in Alliance 2 may have a 5/20/75 mix, and the tiers in Alliance 3 may have a 10/25/65 mix. Indeed, the number of tiers, as well as the percentage of members within each tier, may be determined by the alliance leader or by a number of leaders within the alliance.

TABLE 2
Alliance Tiers.

| | Alliance | | |
|---|---|---|---|
| Tier | Alliance 1 | Alliance 2 | Alliance 3 |

Top Tier (10%)
Middle Tier (20%)
Bottom Tier (70%)

Advantageously, according to some embodiments of the present invention, members may be assigned to each tier automatically based on their score/rank, thereby eliminating the need for manual management by a single leader or a handful of leaders. This feature may be extremely important, especially in massive, multiplayer online games in which an alliance may include hundreds, thousands, or tens of thousands of members for which manual management by alliance leadership would be complicated, if not impossible. Thus, automation of alliance self-organization enables much larger alliance size, which is beneficial to the multiplayer online game for at least two reasons. First, concurrent presence of alliance members is much more likely when an alliance comprises hundreds, thousands, or tens of thousands of members; second, automation facilitates implementation of a “farm” or “seed” program to “feed” deserving members to higher tiers of the alliance, when, otherwise, deserving members may go unnoticed, resulting in their losing interest in the alliance or the online game.

Indeed, in a conventional game alliance system, an alliance leader or a group of alliance leaders may manually alter (e.g., promote or demote) the status of each alliance member. In contrast, according to various embodiments of the present invention, a tier scoring function (TSF) may be automatically applied to selected data compiled automatically for each member of the alliance as the member plays the online game. Advantageously, the TSF tracks, monitors, gathers, and evaluates appropriate game-related statistics (e.g., wins, losses, time of play, etc.), characteristics, or other information of each member. The TSF may then apply these measureable game-related statistics, characteristics, and the like to a suitable formula (e.g., an ELO rating system, number of weeks within the alliance, and the like) to generate a per-player score.

In some implementations, the alliance leadership may define the formula applied to raw member data. For example, the formula may apply a weight to the variables in the score determination, such that more or less emphasis may be applied to each of the various game-related statistics, characteristics, and the like.

Optionally, in some instances, instead of applying a single tier result, assigning members to alliance tiers can be organized to allow for multiple tier schemes, such that each tier of the multiple tier scheme has its own TSF function. Indeed, in a multiple tier scheme, several factors (e.g., member seasonal success, member lifetime success, member loyalty, and so forth) rather than a single factor (e.g., wins/losses) may be used to score and rank alliance members. Within each tier scheme, the TSF may apply the factors from each tier scheme to a suitable formula (e.g., an ELO rating system, number of weeks within the alliance, and the like). The results of the formula may be combined to generate a per-player score.

In some implementations, the alliance leadership may define the formula applied to the factors for each of the multiple tiers. For example, the formula may apply a first weight factor to a pure “player performance” tier portion that may account for, for example, seasonal win/loss statistics of the member and apply a second weight factor to a “loyalty” tier portion that may account for, for example, the amount of time the member has been associated with the alliance (e.g., the number of seasons, the amount of playing time, or the like), the win/loss statistics for all seasons played with the alliance, and so forth. Because the alliance leadership defines the formula applied to each of the multiple tiers, the first weight factor and the second weight factor may vary from alliance to alliance. Advantageously, allowing alliances within a massive, multiplayer online game to self-organize and generate their own multiple tier schemes, enables players of the online game to seek an alliance that rewards their kind of play and their game goals.

Although an embodiment of the invention has been described that includes a two-tiered scheme (e.g., a player performance tier and a loyalty tier), that is done for the purpose of illustration rather than limitation. Additional tiers and other types of tiers are possible within a multiple tier scheme. Moreover, tiers may also be nested. For example, a first tier scheme may be designated for “current season performance” and a second tier scheme may be designated for “lifetime alliance loyalty,” each of which may be nested within a third tier scheme designated for “total performance” that comprises a weighted combination of the first and second tier schemes. Thus, in some implementations, the total performance module 120 can use the loyalty data 123 and alliance play data 124, as well as the results of the TSF module 118 and the alliance performance module 117 to calculate multi-tier, composite scores that, in some variations, include an individual component as well as an alliance component. In general, a total performance score provides a composite evaluation of the performance of each member of an alliance (as compared to other members of the same or different alliance), as well as the performance of the alliance (as compared to other alliances competing) in the virtual environment 202.

Once members have received scores based on the various tier scheme(s), members may then be sorted or otherwise ranked based on their score and the comparative scores of the other members of the alliance. Once the alliance leadership has determined a suitable or desired tier member allocation (e.g., Table 2), each member may be automatically assigned to an appropriate tier within the alliance based on her performance- and/or loyalty-based score/rank.

Advantageously, in some implementations, the TSF process may be applied to data at different intervals (e.g., periodically, continuously, and so forth). For example, in some instances and with some multiplayer online games, a daily or weekly (i.e., periodic) recalculation of each member's score, ranking, and tier assignment may be warranted. Indeed, when players/members desire a more relaxed cadence and/or when the number of players may approach or exceed a million, such a periodic approach to recalculation may be preferred. Such an approach also reduces computer calculation load costs. In other instances, for example, when members are competing for higher tier assignments and leadership positions within the alliance, a continuous approach (e.g., every second, minute, or hour) to recalculation may be preferred.

In some variations, alliances may take a seasonal approach to ranking its membership into alliance tiers. According to a seasonal approach, at the end of the game season (e.g., every month, 6 months, or year), the alliance can provide all members or, alternatively, those members in the bottom tier, with a clean slate, resetting tier assignments as well as the data used in scoring and ranking alliance members. Alternatively or in addition, at the end of a season, a purging function may be applied to the membership, whereby some percentage of the members in the bottom tier may be purged from the alliance. Alliance leadership may determine the reset frequency and the extent of any purging; hence, such functions may vary from alliance to alliance. Indeed, in some variations, the purge/reset module 115 can use member play data 121, loyalty data 123, alliance play data 124, and/or tier data 125, as well as the results of the TSF module 118 (i.e., the scores and ranking of the alliance members), the alliance performance module 117, and/or the total performance module 120 to establish a reset frequency and any purging guidelines for the alliance.

The assignment of alliance members to discrete tiers within the alliance may also provide a mechanism for attribution for the purpose of reward. Multiplayer online games frequently include events that include competitions between alliances that attribute scores to the alliances that perform certain activities, achieve certain goals, and/or accomplish certain missions within the online game. Often, in-game rewards may be awarded to the alliance for achieving certain goals or accomplishing certain missions. For example, in a representative one-on-one online game event that awards one (1) point for a win, the winning alliance, e.g., the first alliance to accumulate 1000 points during the event, may be awarded a prize of $10,000 in game currency. The tier system of the winning alliance may provide an equitable method of distributing the prize among the members of the alliance. For example, 33% of the awarded prize may be split among the alliance members in the top tier, 33% of the awarded prize may be split among the alliance members in the middle tier, and 34% of the awarded prized may be split among the alliance members in the bottom tier. Although, in this example, one-third of the prize was distributed to each tier, this was done for the purpose of illustration rather than limitation, and other award distributions may be used. Alliance leadership may determine the distribution of rewards among alliance members as they see fit and/or necessary to retain members within the alliance.

More particularly, the reward module 116 can use, for example, member play data 121, and alliance play data 124, as well as the results of the TSF module 118, the alliance performance module 117, and/or the total performance module 120 to calculate multi-tier, composite scores that, in some variations, include an individual component as well as an alliance component. In general, a total performance score provides a composite evaluation of the performance of each member of an alliance (as compared to other members of the same or different alliance), as well as the performance of the alliance (as compared to other alliances competing) during the event.

In addition to instances for identifying a winning alliance during an event, it may be desirable for the online game to rank alliances, so that players desiring to join an alliance or to switch from one alliance to another may do so after making an informed decision. In some embodiments, the alliance performance module 117 can use, for example, member play data 121 and alliance play data 124 to calculate scores for each alliance participating in the online game, as well as for each member of each alliance. In general, a score for an alliance (e.g., an aggregate score of the alliance members) provides an indication of how successful the alliance currently is or was, e.g., historically, during the most recent season, and the like. In some implementations, a TSF may be automatically applied to selected data compiled automatically for each alliance and/or each member of the alliance. The results of the TSF may then be combined to rank each alliance, such that the top alliance may be ranked number one, the second best alliance may be ranked number two, and so forth.

For many players of a massive, multiplayer online game, there may be a strong incentive to be the best player within an alliance, to be a member of the best alliance, or both. However, other players may be more mercenary, preferring to opt for an alliance that maximizes their share of any game currency reward. Table 3, for example, provides an example of a distribution of two-factor reward multiplier, i.e., a per-tier-per-alliance multiplier. Although Table 3 shows multipliers that account for only two factors, that is done for the purpose of illustration; those skilled in the art can appreciate that additional or alternate factors may be used to determine a multiplier.

TABLE 3
Pier-Tier-Per-Alliance Multipliers.

| | Alliance | | |
|---|---|---|---|
| | Gold | Silver | Bronze |
| | Medal Alliance | Medal Alliance | Medal Alliance |
| Tier | (3x multiplier) | (2x multiplier) | (1x multiplier) |
| Top Tier (5%) | 3x * 5x = 15x | 2x * 5x = 10x | 1x * 5x = 5x |
| (5x multiplier) | | | |
| Middle Tier (20%) | 3x * 3x = 9x | 2x * 3x = 6x | 1x * 3x = 3x |
| (3x multiplier) | | | |
| Bottom Tier (75%) | 3x * 1x = 3x | 2x * 1x = 2x | 1x * 1x = 1x |
| (1x multiplier) | | | |

In the exemplary Table 3, for alliances: a 3× multiplier may be associated with the best (i.e., gold medal) alliance, a 2× multiplier may be associated with the second best (i.e., silver medal) alliance, and a 1× multiplier may be associated with the third best (i.e., bronze medal) alliance; and, for members: a 5× multiplier may be associated with the 5% of the alliance membership in the top tier, a 3× multiplier may be associated with the 20% of the alliance membership in the middle tier, and a 1× multiplier may be associated with the 75% of the alliance membership in the bottom tier.

The magnitudes of the multiplier values shown in Table 3 are for illustrative and comparative purposes only. The system 100 may use an algorithm and/or machine learning to calculate tier and alliance multipliers. For example, to encourage members to play the online game, multipliers may increase/decrease as member engagement, payments, and so forth increase/decrease, respectively. Alliance multipliers may also be associated with player movement within an alliance, such that, for example, a higher ranking may be attributed to fast-growing (in terms of membership) alliances, while a lower ranking may be attributed to alliances that experience a great deal of turmoil and turnover (in terms of membership).

The calculations of tier and alliance multipliers may be performed to provide approximations and more precise calculations. Approximations may be used as a basis for current alliance ranking, e.g., for use in displaying rankings on a scoreboard. More precise calculations, on the other hand, may be used when determining reward distribution to alliance members. The use of approximations (e.g., for multiplier determinations and/or other alliance management calculations) can improve computer performance by reducing computation complexity or a number of required computations. Additionally or alternatively, computer performance can be improved by performing alliance management calculations at lower frequencies (e.g., hourly or daily, rather than every second or minute).

The tabulated cumulative effect, i.e., the per-tier-pier-alliance effect, shows that a player in the top tier of the gold medal alliance may receive a 15× multiplier, while a player in the bottom tier of the bronze medal alliance may only receive a 1× multiplier. In short, were a reward of $10,000 in game currency scaled by the multipliers in Table 3, alliance members of the former tier and alliance would receive $150,000 (i.e., $10,000×15) in game currency, while alliance members of the latter would receive $10,000 (i.e., $10,000×1) in game currency. Top tier, gold medal alliance members would be incentivized to remain in the top tier (or drop from a 15× to a 9× multiplier) and to maintain gold medal alliance status (or drop from a 15× to a 10× multiplier). Bottom tier, bronze medal alliance members, on the other hand may be incentivize either to attempt to join a gold or silver medal alliance, for which she may receive a 3× or 2× multiplier, or attempt to become a member of the middle or top tier of her current alliance, for which she may receive a 3× or a 5× multiplier. Thus, in addition to encouraging alliance members to try harder to make gains within their alliance, applying multipliers to awards may promote mobility of players between alliances. For example, a player may be incentivized by the multipliers to move to a different alliance and/or alliance tier, where the player may have an opportunity to receive larger rewards. In preferred examples, the multipliers can be configured to encourage such movement of players among the alliances and alliance tiers.

Mobility between alliances, especially transitioning from underperforming alliances to gold, silver, or bronze medal alliances, may be limited by the number of members allowed in an alliance. Hence, even very large (e.g., >10,000 member) alliances may fill up quickly with expectant players who may receive an automatic 3× multiplier bump just by becoming a member tiered in the bottom of the gold medal alliance. For the many players who are not chosen, the players may remain incentivized to raise the status of their alliance among the other alliances and to raise their personal status within their alliance. Thus, overall play can improve.

The per-tier-pier-alliance effect may also contribute to downward mobility as members of the gold medal alliance who are in the middle tier may opt to transition to the silver medal alliance where their chances of gaining the top tier of the silver medal alliance may be more achievable. Such a transition may result in an overall increase in reward multiplier (i.e., from 9× to 10×). Such risks and corresponding rewards may create another level of interest and challenge in the online game.

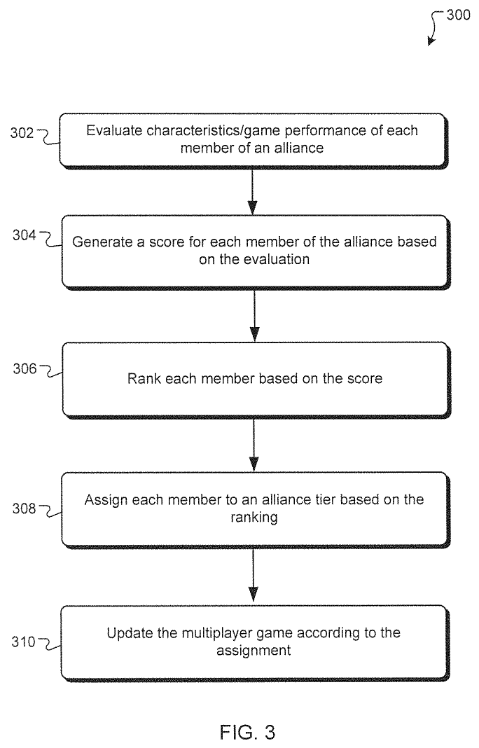

FIG. 3 illustrates an exemplary computer-implemented method 300 for organizing players of a multiplayer online game and, more specifically, to organizing members of an alliance into alliance tiers. In a first step, the method may include evaluating the game performance and/or characteristics of each member of the alliance (STEP 302). In some implementations, such evaluation may include using data automatically compiled about the quality and quantity of the corresponding member's play. For example, the data may include game-related statistics (e.g., win/loss, duration of play, frequency of play, and so forth), game-related characteristics, and other information about the member.

In a next step, based on the evaluation, a score may be generated for each member of the alliance (STEP 304). In some implementations, the score may be generated using a tier scoring function (TSF) that may include evaluating: a level of engagement of the member, a loyalty of the member to the alliance, and/or an ELO rating of the member. In determining the score, a weight factor may be applied to the level of engagement of the member, the loyalty of the member to the alliance, and/or the ELO rating of the member, e.g., according to the perceived or real importance of the element to alliance leadership.

Based on the score, each member of the alliance may be ranked (STEP 306). Based on the rankings, each member may be assigned to one of a plurality of alliance tiers (STEP 308). Once members are assigned to alliance tiers, the game may be updated or otherwise provided according to the assignments (STEP 310). Periodically, e.g., at the end of a season defined by the multiplayer online game, scores and rankings of certain members of an alliance may be reset and/or some portion of the members of an alliance may be purged from the membership of the alliance, opening availability to new members to join the alliance.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method for organizing players of a multiplayer online game as members of a plurality of alliances comprising:
evaluating characteristics of each member in each alliance,
wherein each alliance comprises a plurality of alliance tiers and each alliance tier comprises a portion of the members of the alliance;
generating a score for each member of the alliance based on the evaluation;
ranking each member in each alliance according to the generated scores;
assigning, based on the ranking, each member to an alliance tier of the plurality of alliance tiers; and
updating the multiplayer online game according to the assignments.

2. The method of claim 1, wherein generating the score for each member comprises:
applying a tier scoring function (TSF).

3. The method of claim 2, wherein applying the TSF comprises:
evaluating for each member at least one of:
a level of engagement of the member with the multiplayer online game;
a loyalty of the member to the member's alliance; or
an ELO rating for the member.

4. The method of claim 3, further comprising applying a weighting factor to each of:
the level of engagement of the member;
the loyalty of the member; and
the ELO rating for the member.

5. The method of claim 2, wherein generating the score comprises:
applying the TSF continuously or periodically.

6. The method of claim 1, further comprising:
periodically resetting the score and the ranking of each member.

7. The method of claim 1, further comprising:
periodically purging members in a bottom tier of the plurality of alliance tiers from the alliance.

8. The method of claim 1, further comprising:
evaluating characteristics of each alliance in the multiplayer online game; and
generating an alliance score for the alliance based on the evaluation.

9. The method of claim 8, wherein generating an alliance score comprises:
applying a tier scoring function (TSF) to each alliance.

10. The method of claim 8, further comprising:
providing an in-game reward to at least one player of multiplayer online game, wherein providing the in-game reward comprises:
calculating a multiplier based on the alliance tier of the at least one player and on an alliance score of the alliance of the at least one player.

11. A system comprising:
one or more computer processors programmed to perform operations comprising:
evaluating characteristics of each member in each alliance, wherein each alliance comprises a plurality of alliance tiers and each alliance tier comprises a portion of the members of the alliance;
generating a score for each member of the alliance based on the evaluation;
ranking each member in each alliance according to the generated scores;
assigning, based on the ranking, each member to an alliance tier of the plurality of alliance tiers; and
updating the multiplayer online game according to the assignments.

12. The system of claim 11, wherein generating the score for each member comprises:
applying a tier scoring function (TSF).

13. The system of claim 12, wherein applying the TSF comprises:
evaluating for each member at least one of:
a level of engagement of the member with the multiplayer online game;
a loyalty of the member to the member's alliance; or
an ELO rating for the member.

14. The system of claim 13, further comprising applying a weighting factor to each of:
the level of engagement of the member;
the loyalty of the member; and
the ELO rating for the member.

15. The system of claim 12, wherein generating the score comprises:
applying the TSF continuously or periodically.

16. The system of claim 11, further comprising:
periodically resetting the score and the ranking of each member.

17. The system of claim 11, further comprising:
periodically purging members in a bottom tier of the plurality of alliance tiers from the alliance.

18. The system of claim 11, further comprising:
evaluating characteristics of each alliance in the multiplayer online game; and
generating an alliance score for the alliance based on the evaluation.

19. The system of claim 18, wherein generating an alliance score comprises:
applying a tier scoring function (TSF) to each alliance.

20. An article comprising:
a non-transitory computer-readable medium having instructions stored thereon that, when executed by one or more computer processors, cause the computer processors to perform operations comprising:
evaluating characteristics of each member in each alliance,
wherein each alliance comprises a plurality of alliance tiers and each alliance tier comprises a portion of the members of the alliance;
generating a score for each member of the alliance based on the evaluation;
ranking each member in each alliance according to the generated scores;
assigning, based on the ranking, each member to an alliance tier of the plurality of alliance tiers; and
updating the multiplayer online game according to the assignments.
